(19) United States
(12) Patent Application Publication
(10) Pub. No.: US 2004/0233833 A1
(43) Pub. Date: Nov. 25, 2004

(54) Methods for identifying compounds with thrapeutic potential for treatment of central Neurodegenerative diseases resulting from abnormal protein or peptide accumulation

(76) Inventors: Martin Rechsteiner, Salt Lake City, UT (US); Gregory Pratt, Salt Lake City, UT (US); Jun Li, San Diego, CA (US)

Correspondence Address: NEEDLE & ROSENBERG, P.C., SUITE 1000, 999 PEACHTREE STREET, ATLANTA, GA, 30309-3915, US

(21) Appl. No.: 10/480,608

(22) PCT Filed: Jun. 7, 2002
(86) PCT No.: PCT/US02/18014

Related U.S. Application Data
(60) Provisional application No. 60/297,332, filed on Jun. 11, 2001.

(51) Int. Cl. G11B 5/02

(52) U.S. Cl. 369/292

(57) ABSTRACT

The invention provides a mutant activator of a 20S proteasome. More specifically, relates to a mutant activator comprising a mutant REGγ protein that promotes the 20S proteasome to cleave protein or peptide substrates.

The invention also provides a methods of screening for compounds that inhibit or enhance REGγ activated 20S proteosomal cleavage and method of treating subjects with neurodegenerative diseases characterized by an accumulation of abnormal protein or peptide.

### ACKNOWLEDGEMENTS

This invention was made with government support under Grant GM370009 awarded by the National Institutes of Health. The government has certain rights in the invention.

### BACKGROUND OF THE INVENTION

1. Field of the Invention

This invention relates generally to the treatment of neurodegenerative diseases characterized by accumulation of abnormal proteins or peptides, including, for example, proteins with poly-glutamnine repeats. More specifically, the invention related to methods of using REGγ molecules and proteasomes to identify compounds capable of activating the hydrolysis of peptides diagnostic for each of the three proteasome catalytic subunits. Such compounds would be therapeutically effective in preventing or reducing the accumulation of abnormal proteins and peptides particularly in neurons.

2. Background Art

Thirteen human neurological diseases have been shown to result from expansion of CAG repeats within expressed genes. In eight of these diseases the CAG expansions occur within coding regions, and since CAG encodes glutamine (Q), the expansion produces longer tracts of glutamine than are normally present. Interestingly, in all cases but one, the disease state is manifested when the polyQ tract reaches 35 to 40 contiguous glutamines. The eight proteins that exhibit polyQ expansion have no obvious functional or evolutionary relationships except for the expandable glutamine regions. Two of the polyQ disease proteins, the androgen receptor and a Ca⁺⁺-channel, have defined physiological functions. Expansion of a glutamine tract near the NH2-terminus of the androgen receptor produces Kennedy's disease and glutamine expansion in a cytoplasmic loop of a voltage-dependent, Ca⁺⁺-channel produces one of several forms of ataxia (SCA6). In the latter case, an expansion as short as 10 glutamines produces symptoms. The most prevalent polyQ disease, Huntington's chorea, results from glutamine expansions in a large (3144 aa) cytoplasmic protein of unknown function. Similarly, four ataxias (SCA1, SCA2, SCA3 and SCA7) and dentatorubral-pallidoluysion atrophy (DRPLA) are caused by Q expansions in proteins whose roles in cellular physiology have not yet been discovered. Despite the apparent absence of functional connections between the eight polyQ proteins, the diseases may be manifestations of a common biochemical defect, namely abnormal protein catabolism.

Several features of polyQ neurodegenerative diseases suggest that impaired proteolysis could be at the heart of the pathogenic process. First, it is well established that neurodegeneration is caused by a dominant, gain-of-function toxicity imparted by the expanded glutamine tract rather than by reduced function of the protein bearing the Q expansion. Second, in six of the eight known polyQ diseases, large amounts of the expanded polyQ proteins or fragments thereof accumulate in nuclear inclusions within neurons. In addition, other neurodegenerative diseases, including Alzheimer's and some forms of Parkinson's disease, involve abnormal accumulation of proteins or peptides in the central nervous system (CNS). This suggests that defects in protein degradation, subtle or not so subtle, may underlie pathogenesis. Consistent with this hypothesis is the observation that the polyQ nuclear inclusions, the Lewy bodies of Parkinson's and the tangled neurofilaments present in Alzheimer's all contain proteasomes and/or ubiquitin, the small molecule that targets proteins for destruction. Thus, it is reasonable to speculate that these various neurodegenerative diseases may result from impaired proteolysis either because the protein becomes inherently difficult to degrade or because there are defects in the proteolytic machinery or possibly because the mutant proteins inhibit components of the ubiquitin-proteasome pathway, which is the central proteolytic pathway in eukaryotic cells.

Two additional features of the polyQ diseases deserve mention. Although most of the pathogenic Q-expanded proteins are expressed in many tissues throughout the body, the degenerative process is almost always restricted to neurons. Furthermore, the polyQ proteins or polyQ peptide fragments appear to be more toxic when they gain access to the nucleus.

The 20 S proteasome is the major proteolytic enzyme in the cytoplasmic/ nuclear compartments of eukaryotic cells. The enzyme is composed of four seven-membered rings that stack to form a cylinder. The subunits forming the two end rings are closely related to each other and are members of the α-proteasome subunit family. The proteins forming the two central rings are members of the β-proteasome subunit family. Eukaryotic proteasomes contain three distinct proteolytic β subunits. One subunit is called the trypsin-like subunit because it preferentially cleaves peptide bonds following the basic amino acids, arginine and lysine. A second subunit, which preferentially cleaves peptide bonds following hydrophobic residues, is called the chymotrypsin-like (CT) subunit. The third active subunit preferentially cleaves after glutamate residues, hence the name postglutamyl peptide hydrolyzing (PGPH). The active sites of these subunits face an internal chamber that is sealed off from the external solvent by the α-rings that form each end of the cylindrical proteasome. Sequestration of the active sites requires mechanisms to transfer substrates into the enzyme's central cavity. In this regard, several particles have been discovered that bind the ends of the proteasome and open channels to the central proteolytic chamber.

One of these particles is a donut-shaped molecule called 11 S REG. Red blood cell REG is composed of two subunits, REGα and REGβ which associate to form heptamers. The two proteins are closely related to each other and to a third protein, REGγ, initially identified as an autoantigen in lupus erythematosus patients. REGα and REGβ are highly expressed in the cytoplasm of cells in the immune system and their levels are further increased by γ-interferon (IFN). The REGα/β hetero-heptamer is thought to play a role in antigen presentation on Class I molecules. By contrast, REGγ is a homo-heptamer found principally, if not exclusively, in the nucleus. The role of the REG activators in neurodegenerative diseases, however, was not understood prior to this invention.

### SUMMARY OF THE INVENTION

In accordance with the purpose(s) of this invention, as embodied and broadly described herein, this invention, in one aspect, relates to a mutant activator of a 20S proteasome. More specifically, relates to a mutant activator comprising a mutant REGγ protein that promotes the 20S proteasome to cleave protein or peptide substrates.

In another aspect, the invention relates to a method of screening for compounds that enhance 20S proteasomal cleavage by binding to REGγ or by binding to the proteasome so as to prevent binding of REGγ. Specifically, invention relates to a screening method comprising the steps of (a) contacting a labeled peptide that is cleavable by a proteosomal subunit with the proteasome in the presence of the compound to be screened and in the presence of REGγ and (b) comparing the amount of cleaved, labeled peptide with the amount of cleaved, labeled peptide using the mutant activator of the invention.

In yet another aspect, the invention relates to the treatment of a subject with a neurodegenerative disease characterized by an accumulation of abnormal protein or peptide, comprising administering to the subject a therapeutic amount of one or more compounds that enhance REGγ activated proteasomal cleavage. Preferably, the compound or compounds are identified by the screening method of the present invention.

In yet another aspect, the invention relates to treatment of a subject with a neurodegenerative disease characterized by an accumulation of abnormal protein or peptide, comprising transplanting, into the subject, cells containing a nucleic acid that functionally encodes the mutant activator protein of the invention.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate (one) several embodiment(s) of the invention and together with the description, serve to explain the principles of the invention.

FIG. 1 shows the results of activation of fluorogenic peptide hydrolysis by REGγLys188 mutants. Human red blood cell proteasomes (170 ng) were mixed with increasing amounts of purified REG variants. The reactions were started by adding 50 μl of 200 μMscu-LLVY-MCA, Boc-LRR-MCA, or Boc-LLE-βNA in 10 mM Tris, pH 7.5. After a 10 min incubation, the reaction was quenched with 200μl of cold 100% ethanol, and the released MCA or βNA ws measured fluometrically. Each data point represents the mean of three measurements from a single experiment. Equivalent results were observed in at least two experiments using different preparations of the various REG proteins. REGα (▪), REGγ(□), REGγ(K188E) or REGγ(K188D) (●), REGγ(K188H) (∘), REGγ(K188Q) or REGγ(K188N) (Δ), REGγ(K188A) (♦). The data for REGγ(K188E) and REGγ(K188D) and for REGγ(K188Q) and REGγ(K188N) were combined since their activities were indistinguishable.

FIG. 2 shows the results of a degradation assay for polyQ peptides using molecular exclusion chromatography with fluorescein as a signal.

FIG. 3 shows the degradation products as identified by HPLC-MS.

FIG. 4 shows the results of a degradation assay for the C-terminal 31 residue peptide from the amyloid-β peptide (Aβ) precursor amyloid precursor protein (APP) using molecular exclusion chromatography with fluorescein as a signal.

### DESCRIPTION OF THE PREFERRED EMBODIMENTS

The present invention may be understood more readily by reference to the following detailed description of preferred embodiments of the invention and the Examples included therein and to the Figures and their previous and following description.

Before the present compounds, compositions, articles, devices, and/or methods are disclosed and described, it is to be understood that this invention is not limited to specific synthetic methods, specific mutants, or to particular screening methods, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a proteasome” includes mixtures of proteasomes, and reference to “a peptide bond” includes two or more peptide bonds, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

The present invention provides a mutant activator of a 20S proteasome. More specifically, the mutant activator comprises a mutant REGγ protein that promotes the proteasome to cleave protein or peptide substrates. By “promoting” is meant any detectable increase in the amount of cleavage as compared to the wild-type REGγ protein, including about a 5%, 10%, 15%, 20%, 25%, 30%, 35%, 40%, 45%, 50%, 55%, 60%, 65%, 70%, 75%, 80%, 85%, 90%, 100% or greater increase in the amount of cleavage. Such an increase could be detected using methods known in the art, including fluorescence spectroscopy, FRET (fluorescence resonance energy transfer), or SPA (scintillation proximity assay). See, e.g., Grahn et al. (1999), Biochem Biophys. Acta 1431:329-37 (for methods related to FRET); Grahn et al. (1998), Anal Biochem. 265:225-31 (for methods related to FRET); and Cook (2000) Scintillation Proximity Assay (SPA): A Highly Versatile High Throughput Screening Technology, (www.apbiotech.com/application/Drug_screening/Additional_info/scin_Prox_ass.htm) (for methods related to SPA), which are incorporated herein by reference in their entirety.

By “cleaving protein or peptide substrates” is meant cleaving peptide bonds in the protein or peptide substrate. Preferably, the mutant activator promotes cleavage of peptide bonds after a hydrophobic, basic, acidic amino acid, or any combination thereof In one embodiment, the activator promotes cleavage after one or more glutamine (Q) residues in a poly Q region.

Preferably the mutant activator binds to the proteasome with an affinity that is about 80% or higher than the affinity of a wild-type REGγ protein for the proteasome. The affinity, more preferably, is about 85, 90, 95, or 100 % or higher in its affinity for the proteasome. Affinity can be assessed using a variety of techniques known by one skilled in the art, including, for example, solid phase using tethered proteasomes, surface plasmon resonance, or sedimentation.

In one embodiment, the mutant REGγ protein forms a less stable heptamer than the wild-type REGγ protein. “Less stable” means that the heptamer dissociates upon gel filtration.

In one embodiment, the mutant activator is a mutant REGγ protein that contains a lysine to glutamine substitution at position 188. Optionally, other substitutions or mutations are present in this mutant REGγ protein.

In another embodiment, the mutant activator is a mutant REGγ protein that contains a lysine to aspartic acid substitution at position 188. Optionally, other substitutions or mutations are present in this mutant REGγ protein.

The mutants of the present invention can be made using error prone PCR coupled with an activity screen. Oligonucleotide-directed mutagenesis can be used tro introduce point mutations into the REG protein. See Kunkel T A (1985) Rapid and efficient site-specific mutagenesis without phenotype selection, Proc. Nat'l. Acad. Sci. 82:488-492; Kunkel T A, et al., Rapid and efficient site-specific mutagewnesis withou phenotype selection, Meth. Enzymol. 154:367-382. Other techniques recognized in the art could be used to produce the mutant activators of the present invention.

The invention further provides a method of screening for compounds that inhibit REGγ activation of 20S proteasome, comprising the steps of (a) contacting a first labeled peptide with the proteasome in the presence of REGγ and in the presence or absence of the compounds to be screened, wherein the labeled peptide is cleavable by the proteasome in the presence of REGγ to form one or more first labeled products; (b) detecting the amount of first labeled product or products; and (c) comparing the amount of first labeled product or products in the presence or absence of the compound to be screened. A lower amount of first labeled product in the presence of the compound to be screened indicates a compound that inhibits REGγ activation of the proteasome. Such a screening method also could be used to determine whether a potential therapeutic agent has a deleterious effect on proteasomal cleavage. Thus, identification of the compound would assist in identifying agents that should not be used, particularly in subjects with or with a predisposition to neurodegenerative diseases characterized by an accumulation of abnormal proteins.

Also, if REGγ is inhibiting polyQ cleavage then compounds that prevent REGγ activity could be therapeutically beneficial. To evaluate with the screening method of the present invention, the contacting step is performed in the presence and absence of REGγ and in the presence and absence of the compound(s) to be screened. The labeled peptide is a polyQ peptide, and a higher amount of labeled peptide indicates a compound that prevents REGγ inhibition of polyQ cleavage.

In one embodiment of the method of screening for compounds that inhibit REGγ activation of 20S proteasome, the method further comprises (a) contacting the compound to be screened with proteasome, wherein the compound is labeled, and (b) detecting labeled compound bound to the proteasome. The absence of bound label indicates a compound that inhibits REGγ activation but does not bind to the proteasome directly. Optionally, the method of screening can further comprise (a) contacting a second labeled peptide with proteasome in the presence or absence of the compound to be screened, wherein the second labeled peptide is cleavable by the proteasome to form one or more second labeled products, (b) detecting the second labeled product or products. In this embodiment, a comparable amount of second labeled products in the presence of absence of the compound indicates a compound that inhibits REGγ activation but does not directly affect hydrolysis by the proteasome.

The invention further provides a method of screening for a compound that enhances REGγ activation of 20S proteasome's chymotrypsin-like (CT) and PGPH active sites. In one embodiment, the method comprising the steps of (a) contacting a first labeled peptide with a 20S proteasome in the presence of REGγ and in the presence or absence of the compound to be screened, wherein the first labeled peptide is cleavable by the proteasome in the presence of REGγ to form one or more first labeled products; (b) detecting the amount of first labeled product or products; and (c) comparing the amount of first labeled product or products in the presence or absence of the compound to be screened. A greater amount of first labeled product in the presence of the compound to be screened indicating a compound that enhances REGγ activation of proteasome's CT sites. The first labeled peptide cleavable by the proteasome in the presence of REGγ is specific for the the CT active site, including, for example, LLVY (SEQ ID NO: 1)-MCA, LY-MCA, AAF-MCA.

In one embodiment the method further comprises (a) contacting the compound to be screened with proteasome, wherein the compound is labeled, and (b) detecting labeled compound bound to the proteasome, wherein the absence of bound label indicates a compound that enhances REGγ activation of proteasome but does not bind to the proteasome directly. In yet another embodiment, the screening method further comprises (a) contacting a second labeled peptide with proteasome in the presence or absence of the compound to be screened, wherein the second labeled peptide is cleavable by the proteasome to form one or more second labeled products, (b) detecting the second labeled product or products, wherein a comparable amount of second labeled products in the presence of absence of the compound indicating a compound that enhances REGγ activation of the proteasome but does not directly affect hydrolysis by the proteasome. Control peptides that would not be cleaved in the presence of REGγ include sAAPF (SEQ ID NO:2)-MCA, sGPLGP (SEQ ID NO:3)-MCA, sAAPV (SEQ ID NO:4)-MCA.

The present invention also provides a method of screening for compounds that enhance 20S proteasomal cleavage by binding to REGγ. Specifically, the screening method comprises the steps of (a) contacting a labeled peptide that is cleavable by a proteaosomal subunit with the proteasome in the presence of the compound to be screened and the presence of REGγ and (b) comparing the amount of cleaved, labeled peptide with the amount of cleaved, labeled peptide using the mutant activator of the invention. A compound that enhances cleavage is identified by an amount of cleaved labeled peptide in the presence of the wild-type REGγ that approximates, is the same as, or exceeds the amount observed in the presence of the mutant REGγ. A labeled peptide that is cleavable by a proteasomal subunit includes, for example, a peptide cleavable by the trypsin-like subunit (T-subunit), the chymotrypsin-like subunit (CT-subunit), or the PGPH subunit. An example of a peptide that is specifically cleavable by the chymotrypsin subunit is sucLLVY (SEQ ID NO:1)-MCA. Wild-type REGγ does not promote proteasomal cleavage of sucLLVY (SEQ ID NO:1)-MCA, whereas the mutant REGγ does. Thus, a compound that enhances cleavage of the sucLLVY (SEQ ID NO: 1)-MCA by the wild-type REGγ would be a potential therapeutic for the treatment of neurodegenerative diseases characterized by an accumulation of abnormal proteins or peptides.

As used in the screening method of the invention, peptides can be labeled using a variety of methods including, for example, a fluorescence marker (e.g., fluorescein), radioactivity, enzymatic reaction, streptavidin-biotin, and FRET.

The mutant activators and the screening methods of the present invention are useful in identifying potential therapeutic agents that are useful in the treatment of neurodegenerative diseases characterized by an accumulation of abnormal proteins. Such diseases include Parkinson's disease, Alzheimer's Disease, and the various poly Q diseases, including, but not limited to, Kennedy's disease, Huntington's disease, DRPLA, SCA6, SCA1, SCA2, SCA3, and SCA7. Thus, the present invention provides a method of treating a subject with a neurodegenerative disease characterized by the accumulation of a protein cleavable by 20S proteasome. The method of treatment comprises administering to the subject a therapeutically effective amount of one or more compounds identified by the screening method of the present invention. Thus, a compound or combination of compounds that enhance 20S proteasomal cleavage (e.g., by binding to REGγ or by binding to the proteasome so as to prevent binding of REGγ) are administered to the subject to reduce one or more symptoms of the subject's neurodegenerative disease.

By the term “therapeutically effective amount” of a compound as provided herein is meant a nontoxic but sufficient amount of the compound to provide the desired reduction in one or more symptoms. As will be pointed out below, the exact amount of the compound required will vary from subject to subject, depending on the species, age, and general condition of the subject, the severity of the disease that is being treated, the particular compound used, its mode of administration, and the like. Thus, it is not possible to specify an exact “effective amount.” However, an appropriate effective amount may be determined by one of ordinary skill in the art using only routine experimentation.

The compound or compounds identified by the screening method are prepared using techniques known in the art. The compounds are individually or jointly combined with a pharmaceutically acceptable carrier or vehicle for administration as an immunogen or vaccine to the subject. The terms “pharmaceutically acceptable carrier” or “pharmaceutically acceptable vehicle” are used herein to mean any composition or compound including, but not limited to, water or saline, a gel, salve, solvent, diluent, fluid ointment base, liposome, micelle, giant micelle, and the like, which is suitable for use in contact with living animal or human tissue without causing adverse physiological responses and without interacting with the other components of the composition in a deleterious manner. See, e.g., Remington's Pharmaceutical Sciences, latest edition, by E. W. Martin Mack Pub. Co. Easton, Pa., which discloses typical carriers and conventional methods of preparing pharmaceutical compositions that may be used in conjunction with the preparation of formulations of the agents and which is incorporated by reference herein.

The compounds may be administered orally, parenterally (e.g., intravenously), intramuscularly, intraperitoneally, topically, transdermally, locally, systemically, intraventricularly, intracerebrally, subdurally, or intrathecally. Depending upon the agent and the mode of administration, special provisions may be required to promote the agent to cross the blood brain barrier. One skilled in the art would know to modify the mode of administration, the pharmacologic carrier, or other parameters to circumvent restrictions posed by the blood brain barrier. The amount of active compound administered will, of course, be dependent on the subject being treated, the subject's weight, the manner of administration and the judgment of the prescribing physician.

Depending on the intended mode of administration, the pharmaceutical compositions may be in the form of solid, semi-solid or liquid dosage forms, such as, for example, tablets, suppositories, pills, capsules, powders, liquids, suspensions, lotions, creams, gels, or the like, preferably in unit dosage form suitable for single administration of a precise dosage. The compositions will include, as noted above, an effective amount of the selected drug in combination with a pharmaceutically acceptable carrier and, in addition, may include other medicinal agents, pharmaceutical agents, carriers, adjuvants, diluents, etc.

For solid compositions, conventional nontoxic solid carriers include, for example, pharmaceutical grades of mannitol, lactose, starch, magnesium stearate, sodium saccharin, talc, cellulose, glucose, sucrose, magnesium carbonate, and the like. Liquid pharmaceutically administrable compositions can, for example, be prepared by dissolving, dispersing, etc., an active compound as described herein and optional pharmaceutical adjuvants in an excipient, such as, for example, water, saline aqueous dextrose, glycerol, ethanol, and the like, to thereby form a solution or suspension. If desired, the pharmaceutical composition to be administered may also contain minor amounts of nontoxic auxiliary substances such as wetting or emulsifying agents, pH buffering agents and the like, for example, sodium acetate, sorbitan monolaurate, triethanolamine sodium acetate, triethanolamine oleate, etc. Actual methods of preparing such dosage forms are known, or will be apparent, to those skilled in this art; for example see Remington's Pharmaceutical Sciences, referenced above.

For oral administration, fine powders or granules may contain diluting, dispersing, and/or surface active agents, and may be presented in water or in a syrup, in capsules or sachets in the dry state, or in a nonaqueous solution or suspension wherein suspending agents may be included, in tablets wherein binders and lubricants may be included, or in a suspension in water or a syrup. Where desirable or necessary, flavoring, preserving, suspending, thickening, or emulsifying agents may be included. Tablets and granules are preferred oral administration forms, and these may be coated.

Parental administration, if used, is generally characterized by injection. Injectables can be prepared in conventional forms, either as liquid solutions or suspensions, solid forms suitable for solution or suspension in liquid prior to injection, or as emulsions. A more recently revised approach for parental administration involves use of a slow release or sustained release system, such that a constant level of dosage is maintained. See, e.g., U.S. Pat. No. 3,710,795, which is incorporated by reference herein.

For topical administration, liquids, suspension, lotions, creams, gels or the like may be used as long as the active compound can be delivered to the surface of the skin.

The invention also provides a method of treating a subject with a neurodegenerative disease characterized by an accumulation of abnormal protein or peptide, comprising transplanting, into the subject, cells containing a nucleic acid that functionally encodes the mutant activator protein of the invention. The nucleic acid can be exogeneous (i.e., not originally found in the cell) and can be introduced by any means known in the art, including, for example, infection, transformation, transfection, electroporation, microinjection, calcium chloride precipitation or liposome-mediated transfer. See, e.g., Sambrook et al., Molecular Cloning: A Laboratory Manual, 2nd Ed., Cold Spring Harbor Laboratory, Cold Spring Harbor, N.Y. (1989)).

Preferably at least about 3%, more preferably about 10%, more preferably about 20%, more preferably about 30%, more preferably about 50%, and even more preferably about 75% of the transplanted cells express the mutant activator protein after transplantation. To increase the percentage of cells that express the mutant activator protein, multiple transfections can be performed. For example, one can infect cells with a vector of choice, remove the media after infection, reinfect, etc. and repeat the process to achieve the desired percentage of infected cells. Some viruses, for example, can be viable for about two hours at a 37° C. incubation temperature; therefore, the infection can preferably be repeated every couple of hours to achieve higher percentages of cells that express the desired mutant activator protein.

The nucleic acid can be in any vector of choice, such as a plasmid or a viral vector, and the method of transfer into the cell can be chosen accordingly. As known in the art, nucleic acids can be modified for particular expression, such as by using a particular cell- or tissue-specific promoter, by using a promoter that can be readily induced, or by selecting a particularly strong promoter, if desired.

As used throughout, “subject” refers to an individual. Preferably, the subject is a mammal such as a primate, and, more preferably, a human. “Subjects” can include domesticated animals (such as cats, dogs, etc.), livestock (e.g., cattle, horses, pigs, sheep, goats, etc.), and laboratory animals (e.g., mouse, rabbit, rat, guinea pig, etc.).

As used throughout, by “increase in expression” and similar phrases is meant a rise in the relative amount of mRNA or protein, e.g., on account of an increase in transcription, translation, mRNA stability, or protein stability, such that the overall amount of a product of the nucleic, i.e., an mRNA or polypeptide, is augmented. An “increase” can include expression that was entirely lacking before, for example, when a heterologous gene or nucleic acid is introduced and expressed.

To functionally encode the mutant activator protein (i.e., allow the nucleic acid to be expressed), the nucleic acid can include, for example, expression control sequences, such as an origin of replication, a promoter, an enhancer and necessary information processing sites, such as ribosome binding sites, RNA splice sites, polyadenylation sites and transcriptional terminator sequences. Preferred expression control sequences are promoters derived from metallothionine genes, actin genes, immunoglobulin genes, CMV, SV40, adenovirus, bovine papilloma virus, etc. The nucleic acids can be generated by means standard in the art, such as by recombinant nucleic acid techniques and by synthetic nucleic acid synthesis or in vitro enzymatic synthesis.

For example, the nucleic acid can be a vector comprising a nucleic acid encoding the mutant activator protein. More specifically, the nucleic acid can be a viral vector comprising a nucleic acid encoding the mutant activator protein. One skilled in the art will appreciate that the viral vector can comprise any viral vector amenable to delivery to cells and production of the mutant activator protein. For example, the viral vector can be a recombinant adenovirus vector, adenoassociated viral vectors, lentiviral vectors, pseudotyped retroviral vectors, vaccinia vectors, and physical transfection techniques.

In one embodiment, the cells transplanted into the subject are cells of neural or neuronal lineage. Preferably, the cells are transplanted by localized delivery, such as by intracerebral delivery.

Preferably the nucleic acid that encodes the mutant activator protein is functionally linked to a promoter. By “functionally linked” is meant that the promoter can promote expression of the gene, as is known in the art, such as appropriate orientation of the promoter relative to the gene. Furthermore, the gene preferably has all appropriate sequences for expression of the nucleic acid, as known in the art, to functionally encode, i.e., allow the nucleic acid to be expressed. The nucleic acid can include, for example, expression control sequences, such as an enhancer, and necessary information processing sites, such as ribosome binding sites, RNA splice sites, polyadenylation sites, and transcriptional terminator sequences.

The number of cells transplanted to the subject or the frequency of administration varies depending on the type of neurodegenerative condition, degree of disease or conditions, weight, age, sex, and method of administration. Necessary modifications in the number and frequency may be determined by one of ordinary skill in the art using only routine experimentation given the teachings herein. For example, the number of cells and the frequency of administration can be adjusted by the individual physician in the event of any complication.

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### EXAMPLE 1

### Construction of an Expression Library Encoding Random REGγ Mutants

Error-prone PCR was used to introduce random mutation into the REGγ DNA. See Zhang et al., (1998)Idnetification of an Activation Region in the Proteasome Activator REGα. Proc. Natl. Acad. Sci. 95:2807-2811. The PCR products were inserted into pET26(b) through NdeI/BamHI sites. The resulting plasmid library was transformed into BL21(DE3) cells. About 60% of the isolated colonies contained a single-site mutation.

### EXAMPLE 2

### Isolation of REGγ Mutants Stimulating Chymotrypsin-Like Activity of the Proteasome

Transformants were picked and grown at 37° C. in LB containing 25 μg/ml kanamycin. Protein expression was induced with 0.8 mM IPTG for 2 hours at 30° C. Cells were collected by centrifugation and lysed with 10 mM Tris-HCL, pH 7.5, 0.5% Triton X-100, and 0.3 mg/ml polymixin B sulfate. Aliquots were incubated with 170 ng proteasome and 100 μM LLVY (SEQ ID NO:1)-MCA. After a 10-minute incubation, reactions were terminated with 200 μl of ethanol and fluorescence was measured. See Li et al (2000), The Proteasome Activator 11S REG or PA28: Chimeras Implicate Carboxyl-Terminal Sequences in Oligomerization and Proteasome Binding But Not in the Activation of Specific Proteasome Catalytic Subunits, J. Mol. Biol. 299:641-54. Highly active colonies were rescreened and plasmids were purified and sequenced.

Four positive colonies were isolated from among 1400 colonies expressing mutagenized REGγ plasmids. DNA sequencing identifed the four REGγ mutants as (L38V, K188N), (F102I, K188N), (L71P, K188E), and K188N.

### EXAMPLE 3

### Generation of REGγ Mutants Using Site-Directed Mutagenesis

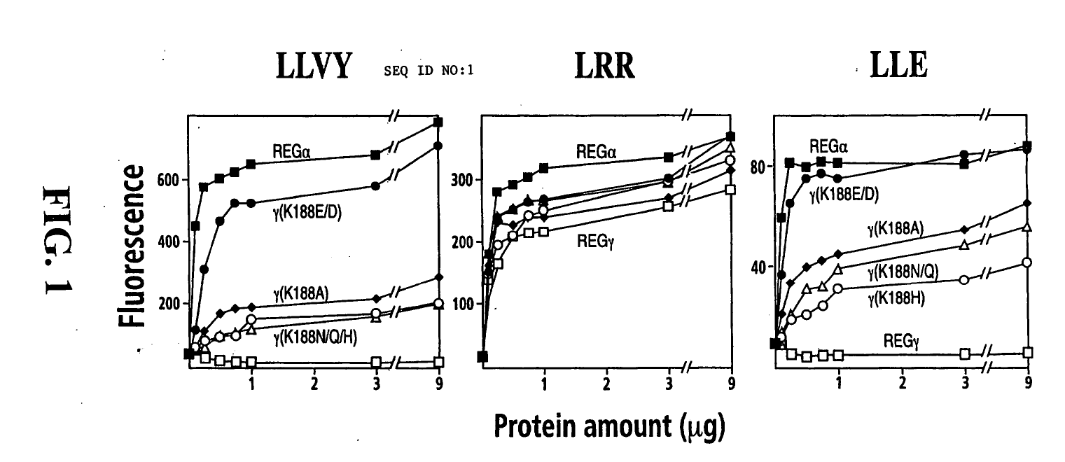

Because each positive variant identified in the previous example included a mutation at Lys188, site-directed mutagenesis was used to generate a series of amino acid substitutions at this residue. Twelve mutants were constructed in which Lys188 of REGγ was changed to Ala, Arg, Asn, Asp, Cys, Gln, Glu, His, Ile, Phe, Pro, or Ser. Wild-type REGγ and the Lys 188 variants were expressed in E. coli, purified, and the activation specificity of each protein was measured using the diagnostic peptides LLVY (SEQ ID NO:1)-MCA, LRR-MCA, and LLE-βNA. The data are summarized in FIG. 1 and Table 1. Except for the K188R variant, all Lys 188 mutants stimulated the hydrolysis of LRR-MCA by the proteasome to the same extent or slightly better than wild-type REGγ. Substitution of negatively-charged Glu or Asp for the positively-charged Lys188 produced mutants with activation properties almost identical to REGα. Eight variants clearly stimulated hydrolysis of LLVY (SEQ ID NO:1)-MCA and LLE-βNA but to extents ranging from 6-fold stimulation exhibited by K188A and K188C to 2-fold stimulation seen with K188I. Replacement of Lys188 with Pro or Arg did not enhance cleavage of peptides diagnostic for the CT-like or PGPH active sites of the proteasome.

TABLE 1
Properties of REGγLys188 Mutants

| | Stimulation of cleavage(x-fold) | | | Percent | Relative affinity for |
|---|---|---|---|---|---|
| | LLVY | LRR | LLE | heptamer | proteasome^{‡} |
| REGγ | 0.4 | 12 | 0.6 | >95% | 100 |
| REGα | 16 | 16 | 9 | ˜95% | 0 |
| γK188E | 14 | 15 | 9 | 50% | 90 |
| γK188D | 14 | 15 | 9 | 50% | 90 |
| γK188A | 6 | 13 | 6 | 60% | 60 |
| γKl88C | 6 | 13 | 5 | 70% | 60 |
| γK188N | 5 | 14 | 5 | 80% | 75 |
| γK188Q | 5 | 14 | 5 | 80% | 75 |
| γK188H | 5 | 14 | 4 | >95% | 50 |
| γK188F | 4 | 13 | 4 | Dimer | 40 |
| γKI88S | 3 | 14 | 3 | >95% | 50 |
| γK188I | 2 | 12 | 3 | >95% | 60 |
| γK188P | 1 | 12 | 1 | 50% | 40 |
| γK188R | 0.7 | 10 | 0.7 | >95% | 75 |

^{‡}Relative proteasome binding affinity was determined in terms of REGα(N146Y)/REGβ(N135Y) competition and does not reflect the actual proteasomal binding by REG molecules.

To determine the degree to which the activation specificity of REGγ(K188E/D) variants matches that of REGα, proteasomal cleavage of a series of fluorogenic peptides was measured in the presence of each activator. The properties of REGγ(K188E/D) are virtually identical to REGα in their ability to activate proteosomal hydrolysis of small fluorogenic peptides. See Table 2.

TABLE 2
Activated Hydrolysis of Fluorogenic
Peptides by REGα, REGγ, and REGγ(K188E/D)

| Fluorogenic | Stimulation of cleavage (x-fold) | | | |
|---|---|---|---|---|
| Peptide | REGγ | γK188E | γK188D | REGα |
| LLVY(SEQ ID NO: 1)-MCA | 0.4 | 14 | 14 | 16 |
| LY-MCA | 2 | 3 | 3 | 5 |
| AAF-MCA | 1 | 4 | 4 | 6 |
| FSR-MCA | 7 | 7 | 7 | 10 |
| VLK-MCA | 5 | 6 | 6 | 7 |
| LRR-MCA | 11 | 15 | 15 | 16 |
| IEGR(SEQ ID NO: 5)-MCA | 1 | 2 | 2 | 3 |
| IETD(SEQ ID NO: 6)-MCA | 1 | 21 | 26 | 30 |
| LGHD(SEQ ID NO: 7)-MCA | 1 | 10 | 11 | 11 |
| DEVD(SEQ ID NO: 8)-MCA | 2 | 8 | 9 | 10 |
| YVAD(SEQ ID NO: 9)-MCA | 0.9 | 7 | 8 | 9 |
| LLE-βNA | 0.6 | 9 | 9 | 9 |

### EXAMPLE 4

### Proteasomal Cleavage of Natural Peptides in the Presence and Absence of REGα, REGγ, or REGγ Mutants

Proteasomal hydrolysis of a 21 -residue peptide (P21) and a 49-residue peptide (BBC1) were prepared as described by Zhang et al. (1998), Proteasome Activation by REG Molecules Lacking Homolog-specific Inserts, J. Biol. Chem. 273:9501-09. Digestion products were applied to a C18 HPLC column and separated with a gradient of 0-45% acetonitrile containing 0.1% trifluoroacetic acid. To identify the products derived from P21, fractions were collected manually, concentrated, and subjected to mass spectrometry.

Wild-type REGγ decreased hydrolysis of P21 by the proteasome. In contrast, REGγ(K188E or D) and REGα markedly increased sunstrate consumption producing more complicated patterns of cleavage products that are clearly different from the products produced by REGγ-proteasome complexes.

Somewhat different results were obtained upon hydrolysis of the longer peptide, BBC1. In the absence of proteasome activators, BBC1 was consumed with a half-life of 85 minutes producing a series of peptides eluting between 34 and 38 minutes. With REGγ present, degradation was faster (t _{1/2}=45 min) and produced HPLC profiles that could be distinguished from the REGγ profile. Taken together, assays using two natural peptides provided evidence that REGγ(K188E or D) variants are equivalent to REGα in activation properties.

### EXAMPLE 5

### Electron Microscopic Analysis of REGγ(K188E)

Electron microscopy was used to compare the oligomeric state of wild-type REGγ and REGγ(K188E), the mutant capable of activating all three proteasomal catalytic subunits. Grids bearing carbon-coated nitrocellulose films were glow-discharged prior to being floated for 2 min on 10 μl drops of sample at a protein concentration of 30 μg/ml. The sample drop was blotted away, and the grid was negatively stained by floating on a drop of 1% uranyl acetate for 10 sec. Specimens were observed in a Phillips EM400T transmission electron microscope, and micrographs were recorded at a nominal magnification of 46,000×.

When REGγ and REGγ(K188E) were examined by negative staining, fields of roundish particles (diameter 11-13 nm) were observed for both samples. The REGγ particles were consistently more uniform in size and appearance than REGγ(K188E). In two independent data sets of REGγ particles, seven-fold symmetry was detected, most strongly at a radius of 5-5.5 nm, around the outer rim of the particle. No other order of symmetry was found to be statistically significant. Correlation averaging of these data depicted a seven-fold symmetric particle, with a heavy accumulation of stain at the center surrounded by a thin annulus of protein density and then seven peripheral outcrops. Thus visualized, REGγ is a heptamer with an outer diameter of about 13 nm.

Although REGγ(K188E) particles tended to be less regular in appearance, statistically significant 7-fold and 6-fold symmetry was detected in well-preserved molecules. The data were partitioned accordingly. Correlation averaging of the 7-fold data depicted a heptamer with is similar in shape and appearance to the wild-type REGγ. The 6-fold data yielded a hexamer that resembles the heptamer apart from its order of symmetry and being smaller. The occurrence of hexamers as well as heptamers in the population of REGγ(K188E) oligomers correlates with the reduced stability of the mutant oligomers upon gel filtration.

### EXAMPLE 6

### Physical Properties of REGγLys188 Variants

To examine the effect of Lys188 substitution on REGγ heptamer stability, the wildtype and Lys 188 variant heptamers were rechromatographed on the Superdex 200 (26/60) size exclusion column used for purification. Wild type REGγ remained fully heptameric, as did REGγ(K188H), REGγ(K188S), REG(K188I), and REGγ(K188R). Similar analyses showed that the percentage of REGγ(K188A), REGγ(K188C), REGγ(K188N), and REGγ(K188Q) that remained heptamers ranged from 60% to 80%. More than half of the REGγ(K188D) and REGγ(K188E) heptamers dissociated during the second gel filtration. See Table 1. Replacement of Lys 188 by Pro or Phe severely affected the stability of REGγ heptamer. About 50% of REGγ(K188P) heptamers dissociated into monomers whereas REGγ(K188F) variants remained monomers or dimers.

As a measure of the relative affinities of REGγ and the REGγLys188 mutants for the proteasome, a competition assay was used. See Li et al. (2000), The Proteasome Activator 11S REG or PA28: Chimeras Implicate Carboxyl-Terminal Sequences in Oligomerization and Proteasome Binding But Not in the Activation of Specific Proteasome Catalytic Subunits. J. Mol. Biol. 299:641-54. All REGγLys188 mutants were relatively resistant to REGα(N146Y)/REGβ(N135Y) competition with apparent proteasome affinities varying from 40% to 90% that of wild-type REGγ. See Table 1. Thus, the REGγLys188 mutants have lower but comparable affinities for the proteasome as does wild-type REGγ.

### EXAMPLE 7

### Affinity Labeling of Proteasome β Subunits in the Presence of REGs

To obtain estimates of substrate access to the proteasome's central chamber in the presence of REGγ and REGγ(K188E), the active site-directed probe, ¹²⁵I-YL3-VS, which covalently modifies all three active β-subunits in an activity dependent manner, was used. See Bogyo et al. (1997), Covalent Modification of the Active Site Threonine of Proteasomal Beta Subunits and the Escherichia coli homolog Hs1V by a New Class of Inhibitors, Proc. Natl. Acad Sci. 94:6629-34; Bogko et al. (1998), Substrate Binding and Sequence Preference of the Proteasome Revealed by Active-Site-Directed Affinity Probes, Chem. Biol. 5:307-20. The phosphoimages show increased labeling of CT/PGPH and T subunits in the presence of REGγ and REGγ(K188E). The data further reveal that REGγ increased the rate of T-subunit labeling 4.7±2.6 (mean±S.D.) fold and the rate of CT/PGPH labeling 4.4±1.7 (mean±S.D.) fold over that seen with proteasome alone. Stimulation by the mutant REGγ(K188E) was greater, being 10.8±4.9 (mean±S.D.) fold for the T-subunit and 11.9±4.8 (mean±S.D.) fold for the CT/PGPH subunit. The increased rate of modification induced by REGγ(K188E) is roughly comparable to its ability to stimulate sustained hydrolysis of fluorogenic peptides at the three active sites. The finding that REGγ increased labeling of the CT and PGPH subunits was unexpected as the wild type activator suppresses hydrolysis of the CT substrate sLLVY (SEQ ID NO:1)-MCA. REGγ promoted entry of the hydrophobic, suicide substrate ¹²⁵I-YL3-VS to the central chamber of the proteasome, suggesting that REGγ binding negatively regulated the proteasome's CT/PGPH active sites.

### EXAMPLE 8

### Proteasomal Degradation of PolyQ Substrates in the Presence and Absence of Mutant and Non-Mutant REGγ

The following peptides were synthesized using routine peptide synthesis:

| | |
|---|---|
| F1-GGQQQQHQHQQQQ | (SEQ ID NO: 10) |
| F1-GGQQQQPQPQQQQ | (SEQ ID NO: 11) |
| F1-GGEPEPEPQQQQPQPQQQ | (SEQ ID NO: 12) |
| F1-GGSKSKSKQQQQPQPQQQQ | (SEQ ID NO: 13) |
| F1-GGQQQQQQQQQQQ | (SEQ ID NO: 14) |

Where F1=fluorescein, G=glycine, Q glutamine, H=histidine, P=proline, K=lysine, S=serine, E=glutamic acid.

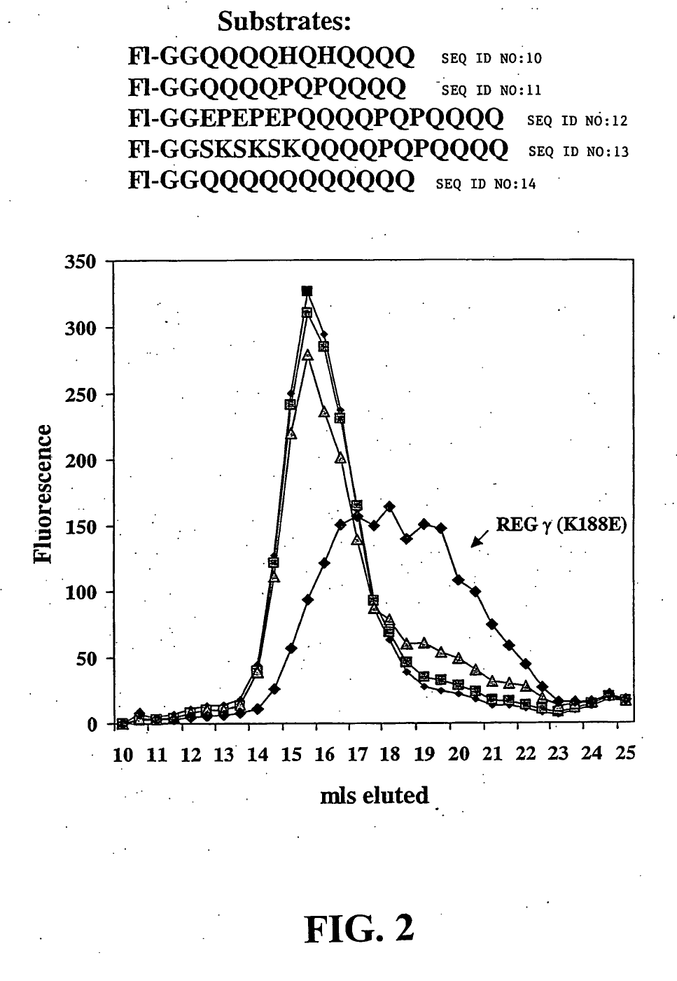

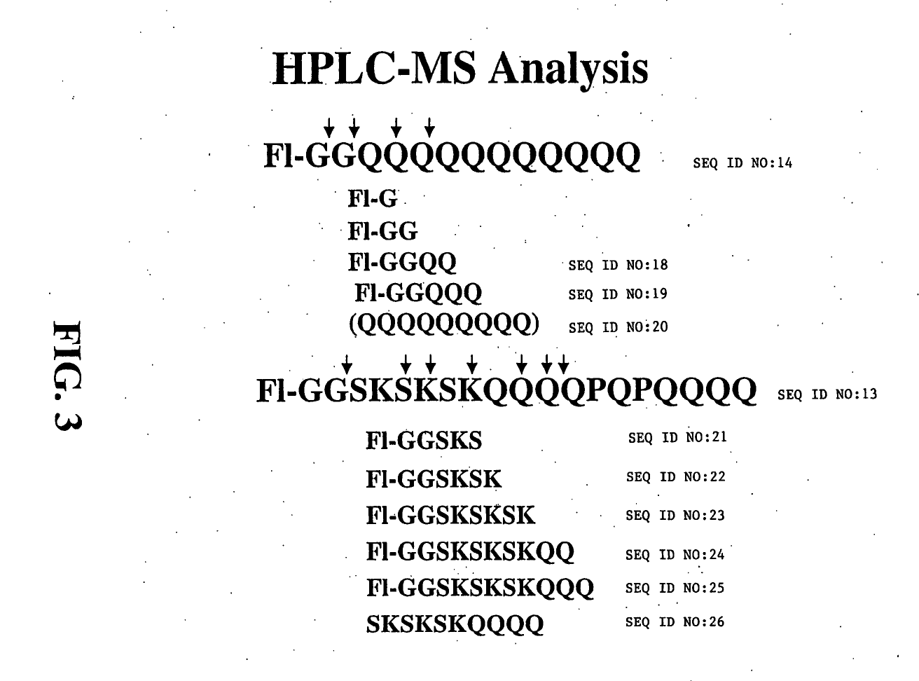

Each peptide was incubated for 5 hr with proteasomes alone, proteasomes+REGγ, proteasome+REGγ(K188E) or proteasomes+REGα/β. Degradation was assayed by molecular exclusion chromatography using fluorescein as a signal (see FIG. 2). The degradation products were identified by HPLC-MS (FIG. 3). The results of these experiments are summarized in Table 3, where it is evident that the polyQ peptides are resistant to degradation by the proteasome alone or by the proteasome plus REGγ. By contrast, in the presence of REGγ(K188E) the various polyQ peptides were degraded 5 to 10-fold faster.

TABLE 3
Proteasomal Degradation of PolyQ Substrates

| | % Degraded | | | |
|---|---|---|---|---|
| | Pro- | Pro- | Pro- | Pro- |
| | teasome | teasome + | teasome + | teasome + |
| Substrates | Only | REGγ | REGγ(K188E) | REGα/β |
| F1-QHQ | 0 | 5 | 50 | 80 |
| F1-QPQ | ˜2 | 5 | 50 | 85 |
| F1-EPQPQ | ˜2 | 5 | 80 | 55 |
| (SEQ ID NO: 15) | | | | |
| F1-KSQPQ | ˜2 | 15 | 80 | 85 |
| (SEQ ID NO: 16) | | | | |
| F1-QQQ | ˜2 | 15 | >95 | 85 |

The mutant REGγ greatly stimulates the proteasome to cleave after glutamine residues. The identification of small molecules that mimic the structural changes and activation properties that occur when Lys 188 of REGγ is mutated to other amino acids could prove very beneficial for patients suffering from polyQ diseases and possibly other neurodegenerative diseases such as Alzheimer's and Parkinson's diseases.

### EXAMPLE 9

### Proteasomal Degadation of a 31-residue C-terminal Peptide of APP in the Presence and Absence of Mutant and Non-Mutant REGγ

A 31-residue C-terminal peptide (C31) of APP, the transmembrane protein that gives rise to amyloid plaque forming Aβ peptides characteristic of Alzheimer's disease, was synthesized using routine peptide synthesis. A fluorescein tag was added to the peptide. C31 peptide is cytotoxic. See Lu et al. (2000), a Second Cytotoxic Proteolytic Peptide Derived from Amyloid Beta-Protein Precursor, Nat. Med. 6:397-404.

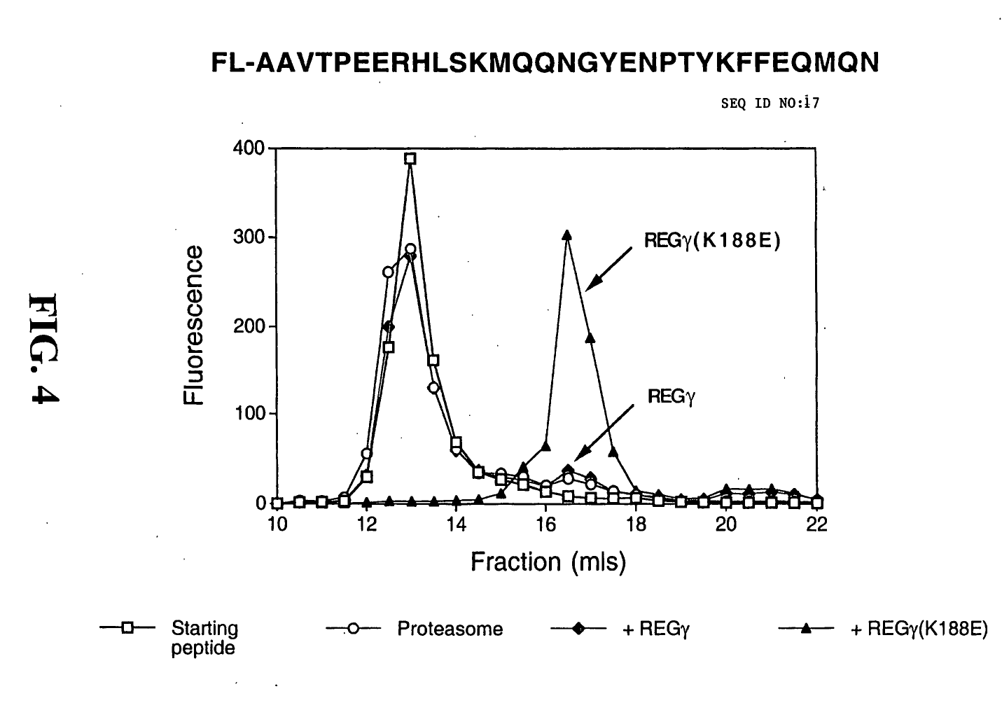

The C31 was incubated with proteasomes alone, proteasomes+REGγ, proteasome+REGγ(K188E) or proteasomes+REGα/β, and degradation was assayed as described in Example 8. Only trace amounts of C31 were degraded by the proteasomes in the presence of REGγ, but the peptide was extensively degraded when REGγ(K188E) was present. See FIG. 4.

### EXAMPLE 10

### Method of Screening for Compounds that Reduce REGγ Activated Proteasomal Cleavage of T-Site Substrates

A compound or combination of compounds to be screened is added to a mixture of proteasomes, REGγ, and a T-site substrate such as LRR-MCA. The amount of cleavage of LRR-MCA is assessed in the presence and absence of the compound or compounds to be screened and in the presence and absence of REGγ. In the absence of the compound or compounds to be screened, REGγ stimulates cleavage of the LRR-MCA substrate 10-20 fold as compared to the basal rate of cleavage in the absence of REGγ. The preferred compound or combination of compounds reduces or prevents the REGγ activated cleavage without reducing the basal rate of cleavage.

Such compounds are identified by incubating 10 ng of proteasomes in 10μl of an appropriate buffer (e.g., 10 mM Tris pH 7.5) containing 0.2 μg of REGγ plus the compound to be screened and 100 μM LRR-MCA in the first reaction. In the second reaction, the compound to be screened is omitted. In a third reaction, the REGγ is omitted and in the forth reaction, both the REGγ and the compound to be screened are omitted. The reactions are incubated for a standard length of time (e.g., 30 min) quenched with ethanol and MCA fluorescence is quantified. Any compound to be screened that inhibited REGγ-mediated proteasome activation, but not the proteasome directly, yields MCA fluorescence values such that values in the first reaction are less than the second but the values in the third reaction are about equal to the fourth reaction.

### EXAMPLE 11

### Method of Screening for Compounds that Promote REGγ Activated Proteasomal Cleavage of CT or PGPH Substrates

A compound or combination of compounds to be screened is added to a mixture of proteasomes, REGγ or REGγ(K188E), and a CT substrate (e.g., LLVY (SEQ ID NO:1)-MCA) or PGPH substrate (e.g., bocLLE-pNA). The amount of cleavage of LLVY (SEQ ID NO:1)-MCA is assessed in the presence and absence of the compound or compounds to be screened and in the presence of either REGγ or REGγ(K188E). In the absence of the compound or compounds to be screened, REGγ(K188E) stimulates cleavage of the CT or PGPH substrate substantially more than REGγ. The preferred compound or combination of compounds promotes REGγ activated cleavage toward the level of REGγ(K188E).

Compounds to be screened are identified using two reactions. Each reaction contains 10 ng proteasomes in 10 μl of an appropriate buffer (e.g., 10 mM Tris pH 7.5) the compound to be screened, and 100 μM sLLVY (SEQ ID NO:1)-MCA (CT substrate) or bocLLE-pNA (PGPH substrate). In the first reaction, 0.2 μg of REGγ are added. In the second reaction, REGγ is omitted. The reaction are incubated for a standard length of time (e.g., 30 minutes), quenched with ethanol. MCA or pNA fluorscence is quantified. A compound that produced greater cleavage in the absence of REGγ is a preferred compound.

The disclosures of any referenced publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A mutant proteasomal activator comprising a mutant REGγ protein that promotes 20S proteasome to cleave protein or peptide substrates.

2. The mutant activator of claim 1, wherein the mutant REGγ protein contains a mutation at position 188.

3. The mutant activator of claim 2, wherein the mutation at position 188 is a lysine to glutamine substitution.

4. The mutant activator of claim 1, wherein the mutation at position 188 is a lysine to aspartic acid substitution.

5. A method of screening for compounds that inhibit REGγ activation of 20S proteasome, comprising the steps of:
(a) contacting a first labeled peptide with the proteasome in the presence of REGγ and in the presence or absence of the compounds to be screened, wherein the labeled peptide is cleavable by the proteasome in the presence of REGγ to form one or more first labeled products;
(b) detecting the amount of first labeled product or products; and
(c) comparing the amount of first labeled product or products in the presence or absence of the compound to be screened;
a lower amount of first labeled product in the presence of the compound to be screened indicating a compound that inhibits REGγ activation of the proteasome.

6. The method of claim 5 further comprising:
(a) contacting the compound to be screened with proteasome, wherein the compound is labeled, and
(b) detecting labeled compound bound to the proteasome, the absence of bound label indicating a compound that inhibits REGγ activation but does not bind to the proteasome directly.

7. The method of claim 6 further comprising
(a) contacting a second labeled peptide with proteasome in the presence or absence of the compound to be screened, wherein the second labeled peptide is cleavable by the proteasome to form one or more second labeled products,
(b) detecting the second labeled product or products,
a comparable amount of second labeled products in the presence of absence of the compound indicating a compound that inhibits REGγ activation but does not directly affect hydrolysis by the proteasome.

8. A method of screening for a compound that enhances REGγ activation of 20S proteasome, comprising the steps of:
(a) contacting a first labeled peptide with a 20S proteasome in the presence of REGγ and in the presence or absence of the compound to be screened, wherein the first labeled peptide is cleavable by the proteasome in the presence of REGγ to form one or more first labeled products;
(b) detecting the amount of first labeled product or products; and
(c) comparing the amount of first labeled product or products in the presence or absence of the compound to be screened;
a greater amount of first labeled product in the presence of the compound to be screened indicating a compound that enhances REGγ activation of proteasome.

9. The method of claim 8 further comprising
(a) contacting the compound to be screened with proteasome, wherein the compound is labeled, and
(b) detecting labeled compound bound to the proteasome,
the absence of bound label indicating a compound that enhances REGγ activation of proteasome but does not bind to the proteasome directly.

10. The method of claim 9 further comprising:
(a) contacting a second labeled peptide with proteasome in the presence or absence of the compound to be screened, wherein the second labeled peptide is cleavable by the proteasome to form one or more second labeled products,
(b) detecting the second labeled product or products,
a comparable amount of second labeled products in the presence of absence of the compound indicating a compound that enhances REGγ activation of the proteasome but does not directly affect hydrolysis by the proteasome.

11. A method of treating of a subject with a neurodegenerative disease characterized by an accumulation of abnormal protein or peptide, comprising administering to the subject a therapeutic amount of one or more compounds identified by the screening method of claim 8.

12. A method of treating of a subject with a neurodegenerative disease characterized by an accumulation of abnormal protein or peptide, comprising administering to the subject a therapeutic amount of one or more compounds that enhance REGγ activated proteasomal cleavage.


SEQUENCE LISTING (26 sequences)

SEQ ID NO: 1 - protein, 4 aa, Artificial Sequence
  Description of Artificial Sequence/note = synthetic construct
LLVY

SEQ ID NO: 2 - protein, 4 aa, Artificial Sequence
  Description of Artificial Sequence/note = synthetic construct
AAPF

SEQ ID NO: 3 - protein, 5 aa, Artificial Sequence
  Description of Artificial Sequence/note = synthetic construct
GPLGP

SEQ ID NO: 4 - protein, 4 aa, Artificial Sequence
  Description of Artificial Sequence/note = synthetic construct
AAPV

SEQ ID NO: 5 - protein, 4 aa, Artificial Sequence
  Description of Artificial Sequence/note = synthetic construct
IEGR

SEQ ID NO: 6 - protein, 4 aa, Artificial Sequence
  Description of Artificial Sequence/note = synthetic construct
IETD

SEQ ID NO: 7 - protein, 4 aa, Artificial Sequence
  Description of Artificial Sequence/note = synthetic construct
LGHD

SEQ ID NO: 8 - protein, 4 aa, Artificial Sequence
  Description of Artificial Sequence/note = synthetic construct
DEVD

SEQ ID NO: 9 - protein, 4 aa, Artificial Sequence
  Description of Artificial Sequence/note = synthetic construct
YVAD

SEQ ID NO: 10 - protein, 13 aa, Artificial Sequence
  Description of Artificial Sequence/note = synthetic construct
GGQQQQHQHQQQQ

SEQ ID NO: 11 - protein, 13 aa, Artificial Sequence
  Description of Artificial Sequence/note = synthetic construct
GGQQQQPQPQQQQ

SEQ ID NO: 12 - protein, 19 aa, Artificial Sequence
  Description of Artificial Sequence/note = synthetic construct
GGEPEPEPQQQQPQPQQQQ

SEQ ID NO: 13 - protein, 19 aa, Artificial Sequence
  Description of Artificial Sequence/note = synthetic construct
GGSKSKSKQQQQPQPQQQQ

SEQ ID NO: 14 - protein, 13 aa, Artificial Sequence
  Description of Artificial Sequence/note = synthetic construct
GGQQQQQQQQQQQ

SEQ ID NO: 15 - protein, 5 aa, Artificial Sequence
  Description of Artificial Sequence/note = synthetic construct
EPQPQ

SEQ ID NO: 16 - protein, 5 aa, Artificial Sequence
  Description of Artificial Sequence/note = synthetic construct
KSQPQ

SEQ ID NO: 17 - protein, 31 aa, Artificial Sequence
  Description of Artificial Sequence/note = synthetic construct
AAVTPEERHLSKMQQNGYENPTYKFFEQMQN

SEQ ID NO: 18 - protein, 4 aa, Artificial Sequence
  Description of Artificial Sequence/note = synthetic construct
GGQQ

SEQ ID NO: 19 - protein, 5 aa, Artificial Sequence
  Description of Artificial Sequence/note = synthetic construct
GGQQQ

SEQ ID NO: 20 - protein, 9 aa, Artificial Sequence
  Description of Artificial Sequence/note = synthetic construct
QQQQQQQQQ

SEQ ID NO: 21 - protein, 5 aa, Artificial Sequence
  Description of Artificial Sequence/note = synthetic construct
GGSKS

SEQ ID NO: 22 - protein, 6 aa, Artificial Sequence
  Description of Artificial Sequence/note = synthetic construct
GGSKSK

SEQ ID NO: 23 - protein, 8 aa, Artificial Sequence
  Description of Artificial Sequence/note = synthetic construct
GGSKSKSK

SEQ ID NO: 24 - protein, 10 aa, Artificial Sequence
  Description of Artificial Sequence/note = synthetic construct
GGSKSKSKQQ

SEQ ID NO: 25 - protein, 11 aa, Artificial Sequence
  Description of Artificial Sequence/note = synthetic construct
GGSKSKSKQQQ

SEQ ID NO: 26 - protein, 10 aa, Artificial Sequence
  Description of Artificial Sequence/note = synthetic construct
SKSKSKQQQQ